(19) United States
(12) Patent Application Publication
(10) Pub. No.: US 2015/0281012 A1
(43) Pub. Date: Oct. 1, 2015

(54) COMMUNICATION SYSTEM, SESSION CONTROL DEVICE, AND TRANSFER CONTROL DEVICE

(71) Applicant: Oki Electric Industry Co., Ltd., Tokyo (JP)

(72) Inventor: Takashi MIZUKAMI, Tokyo (JP)

(73) Assignee: Oki Electric Industry Co., Ltd., Tokyo (JP)

(21) Appl. No.: 14/530,025

(22) Filed: Oct. 31, 2014

(30) Foreign Application Priority Data
Mar. 26, 2014 (JP) 2014-064139

(51) Int. Cl. H04L 12/26; H04L 12/24; H04M 3/42

(52) U.S. Cl. CPC H04L 43/06; H04M 3/42059; H04L 41/0686

(57) ABSTRACT

When an IBCF provided between different types of networks requests information of a receiver, the IBCF can notify a TrGW of call identification information. When the IBCF identifies a call from a log of the TrGW during checking of the log related to the call, the IBCF can use the call identification information. Therefore, the log can be efficiently checked. A session controller configured to connect to a plurality of communication networks of different types and perform a session control, and a transfer controller configured to connect to the plurality of communication networks and perform a packet signal transfer control, are provided. The session controller provides a termination information request message including call identification information for identifying a call included in a call connection request received by the session controller, to the transfer controller.

### CROSS REFERENCE TO RELATED APPLICATION(S)

This application is based upon and claims benefit of priority from Japanese Patent Application No. 2014-064139, filed on Mar. 26, 2014, the entire contents of which are incorporated herein by reference.

### BACKGROUND

The present invention relates to communication systems, session control devices, and transfer control devices. For example, the present invention is applicable to a session control device, transfer control device, and communication system which are provided between different types of networks.

The 3rd Generation Partnership Project (3GPP) has proposed a standardized Border Control Function (BCF) as a function of connecting to an IP Multimedia Subsystem (IMS) network. This BCF has an Interconnection Border Control Function (IBCF) and a Transition Gateway (TrGW). The IBCF provides a signaling function, and the TrGW provides an inter-network connection function involved in transport.

For example, in an IP telephony system, conventional specific techniques for the IBCF and the TrGW are described in the 3GPP specification 3GPP TS 29.162, and techniques for the IBCF-TrGW interface are described in the 3GPP specification 3GPP TS 29.238.

3GPP TS 29.238 specifies that the Media Gateway Control Protocol (MEGACO): ITU-T Recommendation H.248 shall be used between the IBCF and the TrGW. A MEGACO package, which is used at the IBCF-TrGW interface, is described in Clause 5.14 of 3GPP TS 29.238.

FIG. 2 shows a conventional operational flow of a call connection procedure which is performed when the IBCF receives an initial INVITE request. FIG. 2 is defined in 3GPP TS 29.162.

In FIG. 2, when an IBCF 91 receives an initial INVITE request from a corresponding SIP device in the caller network (S91), the IBCF 91 sends an H.248 add request to a TrGW 92 (S92). Here, in the add request, a request for dispensing of a Real-time Transport Protocol (RTP) address and a UDP port with respect to the receiver network is set (Local Addr=Choose, Local Port=Choose).

After having received the add request, the TrGW 92 dispenses an RTP address and an UDP port with respect to the receiver network (S93), and sets the RTP address and the UDP port in an add response, and sends the add response to the IBCF 91 (S94).

The IBCF 91 sets the numbers of the RTP address and the UDP port set in the received add response in the Session Description Protocol (SDP) of an initial INVITE request, and sends the initial INVITE request to the corresponding SIP device of the receiver network.

Here, in S92 of FIG. 2, the IBCF 91 does not set, in the add request, a Call-ID or the caller's telephone number and the receiver's telephone number, which are used to identify a SIP dialog or a call, and therefore, the TrGW 92 is notified of a Call-ID or the caller's telephone number and the receiver's telephone number.

In general, in the case of SIP, a log related to a call, such as a Call Detail Record (CDR) etc., is identified using information of a Call-ID defined in IETF RFC3261, or the caller's telephone number and the receiver's telephone number. For example, if the log is a text file, grep (search) is typically performed using the caller's telephone number and the receiver's telephone number, or a Call-ID. In particular, if log analysis is required when any problem occurs in a system in commercial use, a log related to a call should be quickly extracted and analyzed using the caller's telephone number and the receiver's telephone number, or a Call-ID. For example, JP2006-135522 discloses an IP telephony system.

### SUMMARY

Incidentally, when the IBCF and the TrGW are physically separate devices, the devices output respective logs.

However, as described above, the conventional IBCF does not notify the TrGW of a Call-ID or the caller's telephone number and the receiver's telephone number, which are used to identify a call. Therefore, the log related to a call which is output by the TrGW does not include a Call-ID or the caller's telephone number and the receiver's telephone number. When only a Call-ID and the caller's telephone number and the receiver's telephone number are known as information of a call, it disadvantageously takes time and effort to analyze the log of the TrGW.

In particular, a Context-ID defined in MEGACO is information which is known only by the IBCF and the TrGW. The IBCF does not necessarily output the Context-ID to a log or a CDR. Therefore, when the IBCF does not output the Context-ID to a log or a CDR, there is not information which associates the log of the TrGW with the log of the Session Initiation Protocol (SIP), and therefore, it is disadvantageously difficult to analyze the log of the TrGW.

Thus, when logs of calls of the IBCF and the TrGW are mapped together, it is necessary to use information, such as a Context-ID etc., and it disadvantageously takes time and effort to perform mapping between a Context-ID, and a Call-ID and the caller's telephone number and the receiver's telephone number, during checking of the log.

Therefore, it is desirable that a session controller such as the IBCF and a transfer controller such as the TrGW should cooperate with each other to a greater extent.

According to an embodiment of the present invention, there is provided a communication system including a session controller configured to connect to a plurality of communication networks of different types and perform a session control, and a transfer controller configured to connect to the plurality of communication networks and perform a packet signal transfer control. The session controller provides a termination information request message including call identification information for identifying a call included in a call connection request received by the session controller, to the transfer controller.

According to other embodiment of the present invention, there is provided a session control device configured to connect to a plurality of communication networks of different types and perform a session control, including a controller configured to provide a termination information request message including call identification information included in a received call connection request, to a transfer control device configured to connect to the plurality of communication networks and perform a packet signal transfer control.

According to other embodiment of the present invention, there is provided a transfer control device configured to connect to a plurality of communication networks of different types and perform a packet signal transfer control, including a controller configured to obtain a termination information request message including call identification information included in a call connection request, from a session control device configured to connect to the plurality of communication networks and perform a session control, and send back a response message including termination information.

According to the present invention, the session controller and the transfer controller can cooperate with each other to a greater extent.

### BRIEF DESCRIPTION OF THE DRAWINGS

FIG. 1 is a diagram showing a configuration of a communication system according to an embodiment and an internal configuration of a communication device;

FIG. 2 is a sequence diagram showing an operation of a call connection procedure which is performed when a conventional IBCF receives an initial INVITE request;

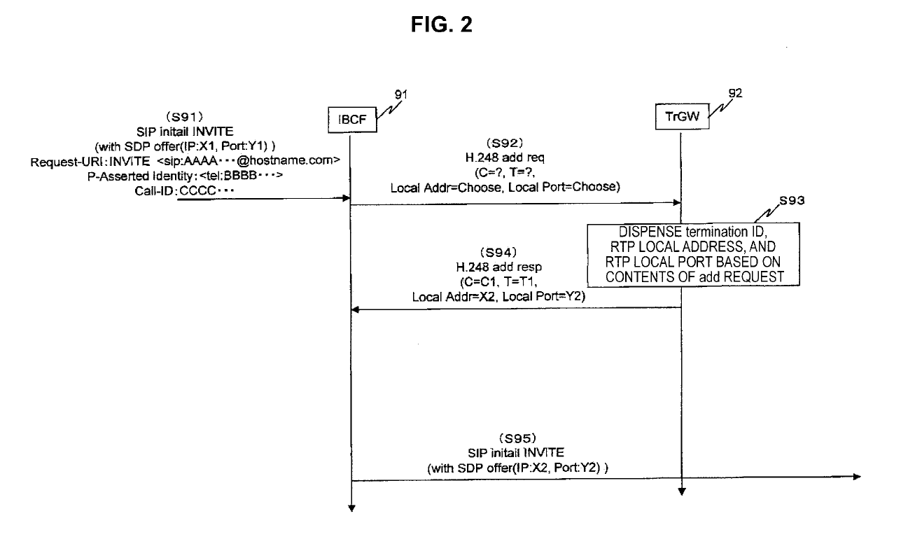

FIG. 3 is a diagram for describing an extension package of a MEGACO add request according to an embodiment;

FIG. 4 is a sequence diagram showing an outline of a communication operation of a communication system according to an embodiment;

FIG. 5 is a sequence diagram showing a signal flow related to call connection of an IBCF and a TrGW in a communication system according to an embodiment; and

FIG. 6 is a diagram for describing example items which a TrGW outputs to a log when a call is released according to an embodiment.

### DETAILED DESCRIPTION OF THE EMBODIMENT(S)

### (A) Main Embodiments

A communication system, session control device, and transfer control device according to an embodiment of the present invention will now be described with reference to the accompanying drawings.

### (A-1) Configuration of Embodiment

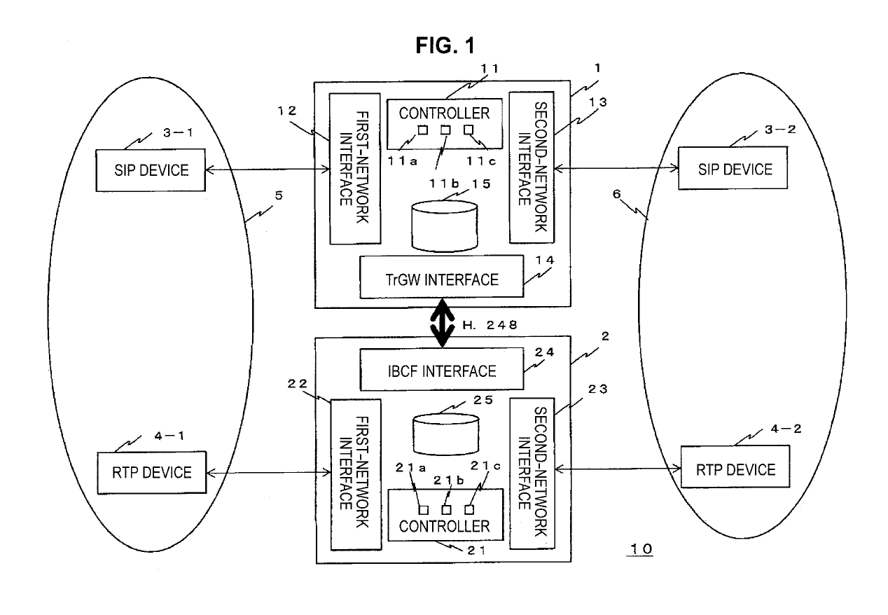

FIG. 1 is a diagram showing a configuration of the communication system of the embodiment and an internal configuration of a communication device.

In FIG. 1, the communication system of this embodiment has a session control device (hereinafter also referred to as an “IBCF”) 1 that serves as a session controller and a transfer control device (hereinafter also referred to as a “TrGW”) 2 that serves as a transfer controller which are connected to a first network 5 and a second network 6.

The first network 5 includes a SIP device 3-1 and an RTP device 4-1, and the second network 6 includes a SIP device 3-2 and an RTP device 4-2.

The first network 5 and the second network 6 may be an IP network whose communication protocol is the Internet protocol (IP). The first network 5 and the second network 6 are assumed to use a SIP for session management of IP multimedia, such as an IP telephony system etc.

The IBCF 1 and the TrGW 2 are provided between the first network 5 and the second network 6 to perform a process of connecting the networks together. The IBCF 1 and the TrGW 2 form a BCF specified in the 3GPP specification 3GPP TS 29.162.

The 3GPP specification 3GPP TS 29.162 specifies various functions included in the system. A single function may be implemented by a single device, or a plurality of functions may be implemented by a single physical device, or a single function may be implemented by a plurality of devices.

In this embodiment, the IBCF 1 and the TrGW 2 are physically different devices, for example.

The IBCF 1 is a signaling device which performs a signaling process in accordance with SIP. The IBCF 1 controls a SIP process between the SIP device 3-1 on the first network 5 and the SIP device 3-2 on the second network 6.

As shown in FIG. 1, the IBCF 1 has a controller 11, a first-network interface 12, a second-network interface 13, a TrGW interface 14, and a storage 15.

The first-network interface 12 is an interface which exchanges packets with the first network 5.

The second-network interface 13 is an interface which exchanges packets with the second network 6.

The TrGW interface 14 is an interface which exchanges information with the TrGW 2. The TrGW interface 14 employs MEGACO (ITU-T Recommendation H.248) specified in 3GPP TS 29.238. The TrGW interface 14 may employ a MEGACO package defined in clause 5.14 of 3GPP TS 29.238.

The storage 15 stores information related to a call as a log under the control of the controller 11.

The controller 11 controls functions of the IBCF 1 which performs a signaling process using SIP. The controller 11 has a CPU, a RAM, a ROM, an EEPROM, an input/output interface, etc. The CPU executes process programs stored in the ROM to carry out the functions of the IBCF 1.

The controller 11 executes various functions, mainly including a SIP process function 11a, a message setting function 11b, a log control function 11c, etc.

The SIP process function 11a exchanges SIP messages with the corresponding SIP device 3-1 and SIP device 3-2 so that the SIP messages are exchanged between the SIP device 3-1 and the SIP device 3-2.

The message setting function 11b, when receiving an initial INVITE request from the SIP device of the caller, creates and sends a MEGACO add request to the TrGW 2 in order to request an RTP address and port number (e.g., an UDP port) of the receiver.

Here, in this embodiment, an extension package is defined in the MEGACO add request in order to notify the TrGW 2 of call identification information for identifying a call. The message setting function llb sets, in the extension package, a Call-ID, which is information corresponding to the caller's telephone number and the receiver's telephone number which is included in the received initial INVITE request.

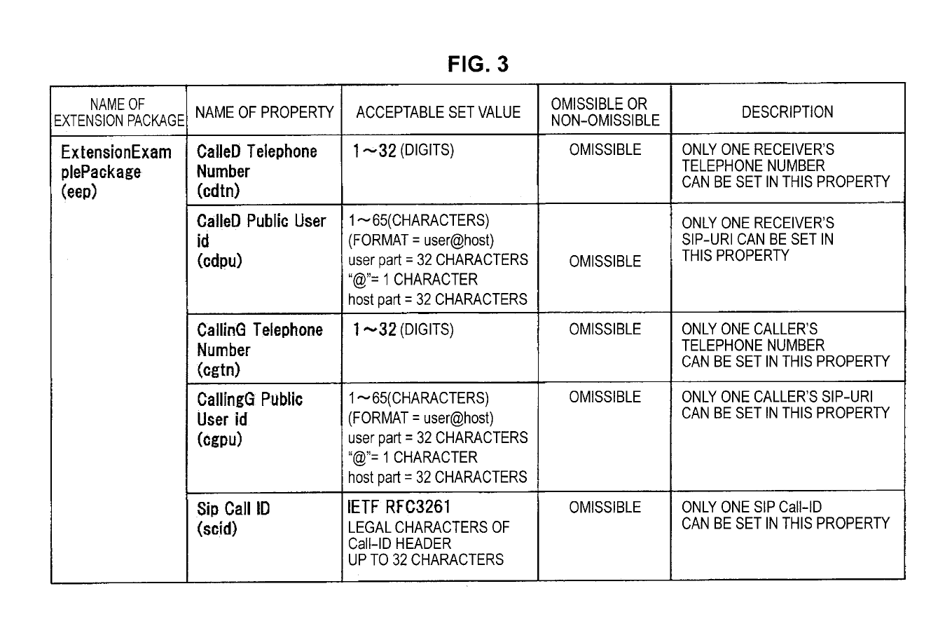

FIG. 3 is a diagram for describing the extension package of the MEGACO add request of this embodiment. Note that the extension package of this embodiment is referred to as “ExtensionExamplePackage (eep).”

As shown in FIG. 3, the extension package defines a CalleD Telephone Number (cdtn) and a CalleD Public User id (cdpu) as information elements related to the receiver, a CallinG Telephone Number (cgtn) and a CallinG Public User id (cgpu) as information elements related to the caller, and a Sip Call ID (scid) as a region for storing a Call-ID of SIP.

Here, in SIP, a SIP-URI, defined in IETF RFC3261, and a tel-URI, defined in IETF RFC3966, are commonly used as information for identifying the caller and the receiver.

In a Request-URI of an initial INVITE request, information of the receiver is set. Therefore, when a SIP-URI is set in a Request-URI of an initial INVITE request received by the IBCF 1, the message setting function llb sets the SIP-URI in the CalleD Public User id (cdpu) of the extension packet of an add request. Also, when a tel-URI is set in a Request-URI of the initial INVITE request received by the IBCF 1, the message setting function 11b sets the tel-URI in the CallinG Telephone Number (cgtn) of the extension package of an add request.

Also, similarly, in the P-Asserted Identity (defined in IETF RFC 3325) header of an initial INVITE request, information of the caller is set. Therefore, when a SIP-URI is set in the P-Asserted Identity header of an initial INVITE request received by the IBCF 1, the message setting function 11b sets the SIP-URI in the CallinG Public User id (cgpu) of the extension package of an add request. Also, when a tel-URI is set in the P-Asserted Identity header of an initial INVITE request received by the IBCF 1, the message setting function 11b sets the tel-URI in the CallinG Telephone Number (cgtn) of the extension package of an add request.

The message setting function 11b also sets a Call-ID of an initial INVITE request received by the IBCF 1 in the Sip Call ID (scid) of the extension package of an add request.

The log control function 11c controls recoding, outputting, analysis, etc. of log information related to a call. An existing technique is applicable to the log control function 11c. For example, when a log related to a call, such as a CDR etc., is identified, the log is managed based on call identification information, such as information of a Call-ID, the caller's telephone number and the receiver's telephone number, etc., which are defined in IFTF RFC3261.

The TrGW 2 is an RTP control device which allows for exchange of RTP packets between networks. The TrGW 2 allows for transmission and reception of RTP packets between the RTP device 4-1 on the first network 5 and the RTP device 4-2 on the second network 6.

As shown in FIG. 1, the TrGW 2 has a controller 21, a first-network interface 22, a second-network interface 23, an IBCF interface 24, and a storage 25.

The first-network interface 22 is an interface which exchanges packets with the first network 5.

The second-network interface 23 is an interface which exchanges packets with the second network 6.

The IBCF interface 24 is an interface which exchanges information with the IBCF 1. The IBCF interface 24 employs MEGACO (ITU-T Recommendation H.248) specified in 3GPP TS 29.238. The IBCF interface 24 may employ a MEGACO package defined in clause 5.14 of 3GPP TS 29.238.

The storage 25 stores information related to a call as a log under the control of the controller 21.

The controller 21 controls functions of the TrGW 2 which performs a process related to RTP packets exchanged. The controller 21 has a CPU, a RAM, a ROM, an EEPROM, an input/output interface, etc. The CPU executes process programs stored in the ROM to carry out the functions of the TrGW 2.

The controller 21 executes various functions, mainly including an address control function 21a, a log control function 21b, an exchanged RTP packet amount measuring function 21c, etc.

The address control function 21a, when receiving a MEGACO add request from the IBCF 1, dispenses an RTP address and a port number the with respect to the receiver network, and sends a MEGACO add response including the RTP address and port number of the receiver network to the IBCF 1.

The log control function 21b obtains the call identification information included in the MEGACO add request from the IBCF 1, and uses the call identification information to record, output, analyze, etc., information related to a call as a log. Note that the call identification information is information including a Call-ID, which is information corresponding to the caller's telephone number and the receiver's telephone number, etc., which is set in the extension package of the MEGACO add request of FIG. 3.

The exchanged RTP packet amount measuring function 21c measures the amount of RTP packets sent and the amount of RTP packets received. Note that the exchanged RTP packet amount measuring function 21c is an example log analyzing means. A means which executes other functions may be used as the log analyzing means.

### (A-1) Configuration of Embodiment

Next, an operation of a communication process in a communication system 10 according to this embodiment will be described in detail with reference to the drawings.

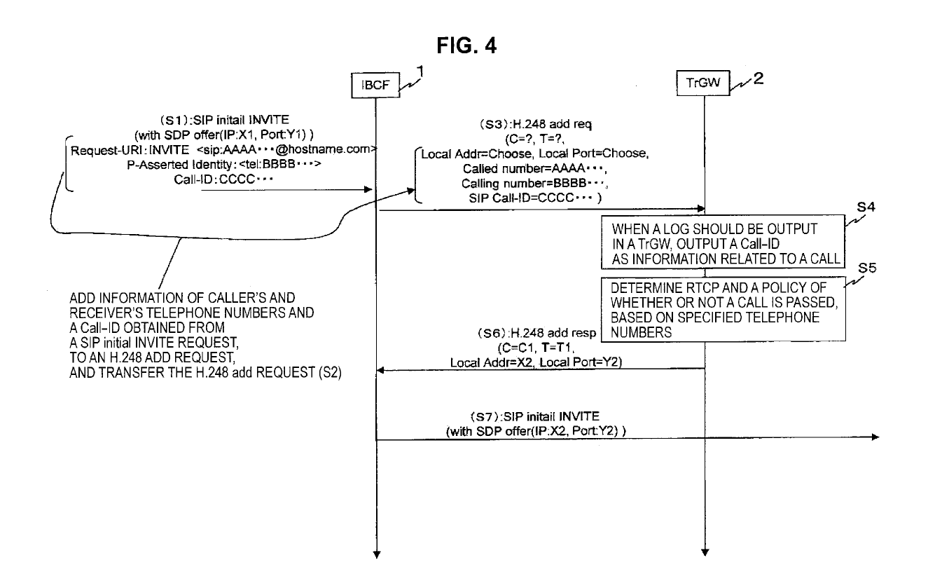

FIG. 4 is a sequence diagram showing an outline of the communication operation of the communication system 10 of the embodiment.

In FIG. 4, the IBCF 1 receives an initial INVITE request from a caller SIP device (here, e.g., the SIP device 3-1) to the receiver SIP device (here, e.g., the SIP device 3-2) (S1).

In the IBCF 1, the controller 11 sets “AAAA . . . ” described in the part before @ of <sip:AAAA . . . @hostname.com>, which is included as information of the receiver in the Request-URI of a received initial INVITE request, in the cdpu of the extension package of a MEGACO add request.

The controller 11 also sets “RBBB . . . ” of <tel:BBBB . . . >, which is included as information of the caller in the P-Asserted Identity header of the initial INVITE request, in the cgtn of the extension package of the MEGACO add request.

The controller 11 also sets “CCCC . . . ” of the Call-ID “CCCC . . . ” of the initial INVITE request in the scid of the extension package of the MEGACO add request.

As described above, the IBCF 1 sends the MEGACO add request including the caller's telephone number and the receiver's telephone number, and the Call-ID, to the TrGW 2 (S3).

The TrGW 2 determines whether or not a log should be output in the TrGW 2. When a log should be output, the TrGW 2 outputs a Call-ID as information related to a call (S4).

The TrGW 2 also determines a policy related to RTCP based on the caller's telephone number and the receiver's telephone number specified by the MEGACO add request from the IBCF 1 (S5).

The TrGW 2 also sends, to the IBCF 1, a MEGACO add response including a termination ID, an RTP address (local address), and a port number (RTP local port) as information of the receiver network, which are based on the contents of the add request of the IBCF 1 (S6).

Thereafter, the IBCF 1 sets the RTP address and port number of the receiver of the received add response in the SDP of an initial INVITE request, and sends the initial INVITE request to the SIP device 3-2 of the receiver (S7).

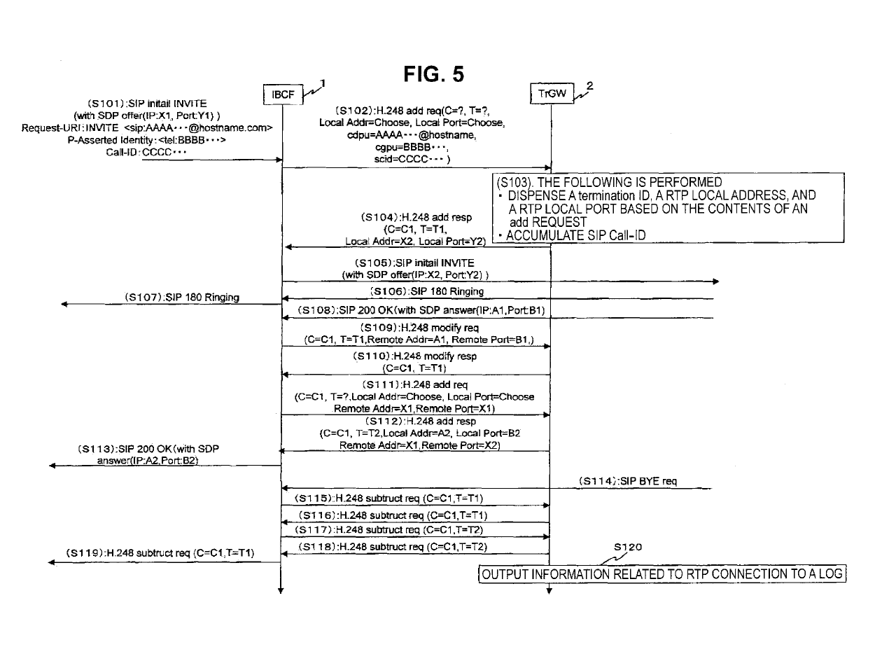

FIG. 5 shows a sequence indicating a signal flow related to call connection of the IBCF 1 and the TrGW 2 in the communication system 10 of the embodiment.

The IBCF 1, when receiving an initial INVITE from the SIP device 3-2 of the caller (S101), sends a MEGACO add request to the TrGW 2 (S102).

Here, the IBCF 1 sets information of the Request-URI of the received initial INVITE request in the CalleD Telephone Number (cdtn) or CalleD Public User id (cdpu) of the add request, information of the P-Asserted Identity header of the initial INVITE request in the CallinG Telephone Number (cgtn) or CallingG Public User id (cgpu), and information of the SIP Call-ID header in the Sip Call ID (scid) of the MEGACO add request.

Note that when the P-Asserted Identity header is not added to the initial INVITE request, the IBCF 1 may not set the P-Asserted Identity header in the CallinG Telephone Number (cgtn) or CallingG Public User id (cgpu) of the add request.

The TrGW 2, when receiving the MEGACO add request, accumulates information of the receiver (the CalleD Telephone Number (cdtn) or the CalleD Public User id (cdpu)), information of the caller (the CallinG Telephone Number (cgtn) or the CallingG Public User id (cgpu)), and the Sip Call ID (scid), which are included in the add request, and dispenses an RTP address and UDP port number of the TrGW 2 with respect to the receiver network (S103), and returns a MEGACO add response (S104).

In S103, the information of the receiver (information corresponding to the receiver's telephone number), the information of the caller (information corresponding to the caller's telephone number), and the Call-ID, which are accumulated in the TrGW 2, are kept until the TrGW 2 outputs a log.

After having received the MEGACO add response, the IBCF 1 sets the dispensed RTP address and UDP port number in the SDP of an initial INVITE request, and sends the initial INVITE request to the SIP device 3-2 of the receiver (S105).

In S106, the SIP device 3-2 returns the 180 provisional response of the initial INVITE request, which indicates that ringing has been started in the receiver, to the IBCF 1.

The IBCF 1, when receiving the 180 provisional response of the initial INVITE request, sends a 180 provisional response to the SIP device 3-1 of the caller without accessing the TrGW 2 because SDP is not contained (S107).

In S108, the IBCF 1, when receiving 200 OK with respect to the initial INVITE request from the SIP device 3-2 of the receiver, sets the RTP address and UDP port number of the receiver added to the SDP of the received 200 OK in a MEGACO modify request, and sends the MEGACO modify request to the TrGW 2 (S109).

The TrGW 2, when receiving the modify request, returns a modify response to the IBCF 1 (S110), and establishes a Termination of the receiver.

Here, as described in Clause 6 of ITU-T Recommendation H.248.1, the basic concept of MEGACO includes Contexts and Terminations. The IBCF 1 shall establish a Termination in each of the caller and the receiver. The Terminations of the caller and the receiver are associated with each other by a Context. In the example of FIG. 5, an identifier for the Termination of the receiver is indicated by “T1,” an identifier for the Termination of the caller is indicated by “T2,” and an identifier for the Context which associates “T1” and “T2” together is indicated by “C1.”

Following this, in order to establish the Termination of the caller, the IBCF 1 sends, to the TrGW 2, an add request including a request for dispensing of an RTP address and UDP port number of the caller, and an RTP address and UDP port number of the TrGW 2 with respect to the caller network (S111).

The TrGW 2, when receiving the add request of S111, dispenses an RTP address and UDP port of the TrGW 2 with respect to the caller, sets the RTP address and UDP port of the TrGW 2 in an add response, and sends the add response to the IBCF 1 (S112).

The IBCF 1, when receiving the add response from the TrGW 2, sends a 200 OK response with respect to the initial INVITE request to the SIP device 3-1 of the caller (S113). As a result, a call is established in the IBCF 1, and an RTP session is established in the TrGW 2, so that conversation begins.

At the end of the conversation, the IBCF 1 receives BYE from the SIP device 3-1 of the caller or the SIP device 3-2 of the receiver (S114). Note that FIG. 5 illustrates a case where the IBCF1 receives BYT from the SIP device 3-2 of the receiver.

After having received BYE, the IBCF 1 initially sends a MEGACO subtract request in order to release the Termination of the receiver (S115). After having received the subtract request, the TrGW 2 releases the Termination of the receiver, and sends a subtract response to the IBCF 1 (S116).

Following this, the IBCF 1 sends a MEGACO subtract request to the TrGW 2 in order to release the Termination of the caller (S117).

After having received the subtract request, the TrGW 2 releases the Termination of the caller, and sends a subtract response to the IBCF 1 (S118). After having completed release of the Termination, the IBCF 1 transfers BYE to the SIP device 3-1 of the caller (S119).

On the other hand, after having completed release of both of the Terminations of the caller and the receiver, the TrGW 2 outputs information related to the call to a log (S120).

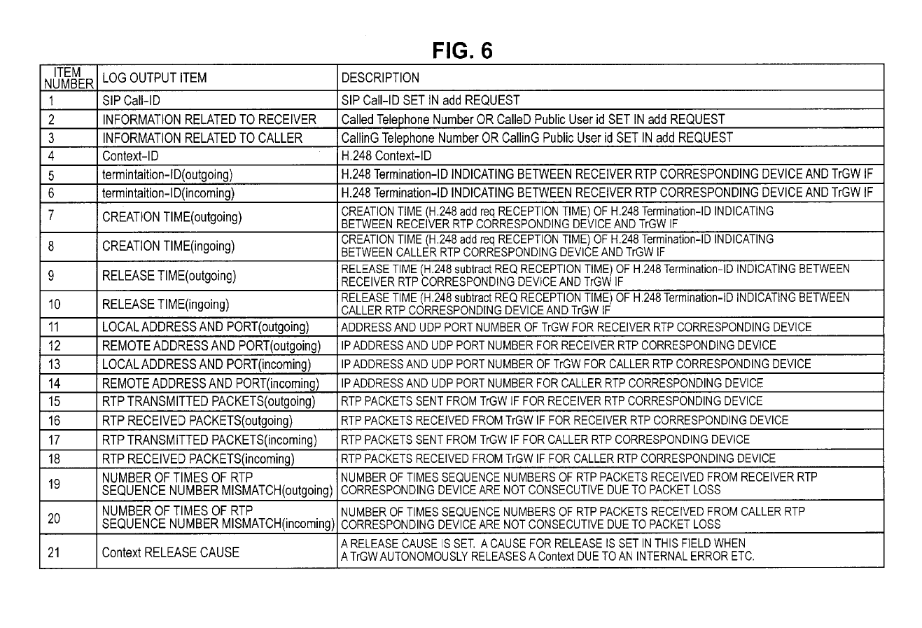

FIG. 6 is a diagram for describing example items which the TrGW 2 outputs to a log when a call is released according to this embodiment.

There are 21 items, “item 1” to “item 21,” which are output to a log, in FIG. 6. Specifically, the items include a “SIP Call-ID,” “receiver information,” “caller information,” a “Context-ID,” a “Context release cause,” etc.

Here, the TrGW 2 receives the add request of S102 of FIG. 5, and outputs information related to the receiver, information related to the caller, and the SIP Call-ID, which have been accumulated, to items of a log. If, by outputting the information related to the receiver, the information related to the caller, and the SIP Call-ID to a log, the caller's telephone number, the receiver's telephone number, or a SIP Call-ID, which are related to a call, is known, log information associated with it can be easily extracted.

Also, in “item 21” of FIG. 6, a “Context release cause” is prepared as a field to which information required for analysis is output when the TrGW 2 autonomously releases an RTP session due to an internal error etc. When the TrGW 2 autonomously releases an RTP session, then if information indicating the autonomous release is output to “item 21” of FIG. 6, the Call-ID, caller's telephone number, and receiver's telephone number of a call autonomously released by the TrGW 2 are known from the log, and therefore, a call or end user for which service is affected by the autonomous release of the TrGW 2 can be easily identified.

### (A-3) Advantages of Embodiment

As described above, according to this embodiment, the same information as the information of FIG. 4 which is used by a SIP device to identify a call is added to a MEGACO add request, and a TrGW outputs the information of FIG. 4 to a log. Therefore, the problems described in the BACKGROUND section, i.e., the problem that it takes time and effort to analyze a log of a TrGW, and the problem that when an IBCF has not output a Context-ID to a log or a CDR, there is not information which associates a log of a TrGW with a log of a SIP, and therefore it is difficult to analyze the log of the TrGW, can be solved. Specifically, according to this embodiment, when an IBCF requests an RTP address and UDP port of a receiver network from a TrGW, the IBCF notifies the TrGW of a Call-ID, a caller's telephone number, and a receiver's telephone number, which are used to identify a call. Also, when a TrGW identifies a call based on a log of the TrGW, a Call-ID, a caller's telephone number, and a receiver's telephone number can be used. Therefore, the log can be efficiently checked.

Also, according to this embodiment, information for identifying a call which is illustrated in FIG. 6 is associated with information indicating that a TrGW has autonomously released an RTP session, and therefore, a call or end user for which service is affected when the TrGW autonomously releases an RTP session, can be advantageously easily identified.

### (B) Other Embodiments

A number of variations of the embodiment have been described above. The present invention is also applicable to the following variations.

The subject matter of the present invention is that an IBCF sets information of a caller, information of a receiver, and a SIP Call-ID, such as those shown in FIG. 3, in a MEGACO add request.

In the above embodiment, an SDP answer is added to 200 OK with respect to an initial INVITE request in FIG. 5. Alternatively, an SDP answer may be added to a 1xx provisional response with respect to an initial INVITE request.

Also, in the above embodiment, disconnection is performed using BYE from a SIP device of a receiver in FIG. 5. Alternatively, the present invention is also applicable to a case where disconnection is performed using BYE or CANCEL from a SIP device of a caller.

What is claimed is:

1. A communication system comprising:
a session controller configured to connect to a plurality of communication networks of different types and perform a session control; and
a transfer controller configured to connect to the plurality of communication networks and perform a packet signal transfer control,
wherein the session controller provides a termination information request message including call identification information for identifying a call included in a call connection request received by the session controller, to the transfer controller.

2. The communication system according to claim 1, wherein
the termination information request message is a MEGACO add request that includes a SIP Call-ID for identifying the call.

3. The communication system according to claim 1, wherein
the termination information request message is a MEGACO add request that includes a SIP-URI or tel-URI indicating information of a receiver included in a call connection request received by the session controller.

4. The communication system according to claim 1, wherein
the termination information request message is a MEGACO add request that includes a SIP-URI or tel-URI indicating information of a caller included in a call connection request received by the session controller.

5. The communication system according to claim 2, wherein
the transfer controller outputs log information including call identification information including all or a part of a SIP Call-ID, information of a receiver, and information of a caller, the call identification information being obtained from the session controller.

6. The communication system according to claim 5, wherein
the transfer controller outputs call identification information including all or a part of a SIP Call-ID, information of a receiver, and information of a caller, and log information during autonomous release of an RTP session, in association with each other.

7. A session control device configured to connect to a plurality of communication networks of different types and perform a session control, comprising:
a controller configured to provide a termination information request message including call identification information included in a received call connection request, to a transfer control device configured to connect to the plurality of communication networks and perform a packet signal transfer control.

8. A transfer control device configured to connect to a plurality of communication networks of different types and perform a packet signal transfer control, comprising:
a controller configured to obtain a termination information request message including call identification information included in a call connection request, from a session control device configured to connect to the plurality of communication networks and perform a session control, and send back a response message including receiver information.
